(19) United States
(12) Patent Application Publication
(10) Pub. No.: US 2008/0036193 A1
(43) Pub. Date: Feb. 14, 2008

(54) Three images in one

(75) Inventors: Monique Golaire, Linkebeek (BE); Maryke Degryse, Assebroek (BE); Nathalie Paquot, Emines (BE); Paul Van Braeckel, Meigem (BE); Beni Haeyaert, Assebroek (BE)

Correspondence Address: JAMES C. WRAY, 1493 CHAIN BRIDGE ROAD, SUITE 300, MCLEAN, VA, 22101, US

(73) Assignee: National Bank of Belgium

(21) Appl. No.: 11/715,595

(22) Filed: Mar. 8, 2007

(30) Foreign Application Priority Data
Aug. 11, 2006 (EP) 06118825.6

(51) Int. Cl. B42D 15/00

(52) U.S. Cl. 283/67; 283/109

(57) ABSTRACT

The present invention relates to a method for printing a security item on a substrate of which at least a part is made of a transparent material, whereby the method comprises following steps:
printing a first image, which is visible or can be visualized, on one side of the transparent material;
printing a second image, which is visible or can be visualized oh the opposite side of the transparent material, wherein the first and second image at least partially overlap;
printing a third image, which is visible or can be visualized in transmission on the zones of the transparent material that are not covered by the first and/or second image.

### BACKGROUND OF THE INVENTION

This application claims the benefit of European Application No. 06118825.6 filed Aug. 11, 2006, which is hereby incorporated by reference in its entirety.

The present invention relates to a method for printing a security item on a substrate of which at least a part is made of a transparent material. This invention in particular relates to a method for printing a security item on security documents on a part of a security document or on a substrate that can be transferred to a security document. Security documents are in particular: banknotes, postage stamps, identity cards, passports, checks, certificates, certificates of authenticity, . . . . The present invention also relates to a printed security item manufactured according to such a method.

Printing security documents, so called security printing is an application or combination of printing technologies such as offset, intaglio, silkscreen and letterpress. Security printing encompasses the printing of banknotes, postage stamps, stamps, stock certificates, identity cards, passports, checks, deeds, plane tickets, diploma's and other documents needing a protection against counterfeiting.

Security papers, such as banknotes circulate in a world where the threat of the counterfeiter is ever present. With the development of new printing processes and the introduction of new technologies, more methods of reproduction are available to the counterfeiter than ever before. It is therefore essential that security documents, such as banknotes should be practically forgery proof. This is achieved not only by the way in which the printing technologies and their combinations are used, but also through the nature of the substrate and the ink, and the use of special additional elements such as security threads, holograms, and so on.

Banknotes are generally printed on a substrate made of 100% cotton and are further protected by a watermark, a security thread, fluorescent fibres of different colours and length, optical variable inks or other visual or machine detectable characteristics.

However, a disadvantage of such banknotes is their restricted lifespan. Banknotes in a synthetic material do not have this drawback, as they can last about four times as long as the conventional cotton notes. The plastic note technology uses a polymer plastic substrate instead of paper. Compared to paper, plastic banknotes are stronger and non-porous.

However, plastic banknotes have the disadvantage that a number of safety features such as real multitone watermarks, windowed security threads which are successfully used in paper notes, can not be used or are less effective when used in plastic notes.

### SUMMARY OF THE INVENTION

Therefore it is an object of the present invention to provide a new method for printing security items, in particular, a method for printing a security item on banknotes, with which the above mentioned drawbacks are overcome and which results in a security item with a much higher security level against counterfeiting than the known methods.

The above mentioned object is achieved by providing a new method for printing a security item on a substrate of which at least a part is made of a transparent material, whereby the method comprises the following steps:
printing a first image, which is visible or can be visualized, on one side of the transparent material;
printing a second image, which is visible or can be visualized on the opposite side of the transparent material, wherein the first and second image at least partially overlap;
printing a third image, which is visible or can be visualized in transmission on the zones of the transparent material that are not covered by the first and/or second image.

In a preferred method according to this invention the method comprises the following steps:
first printing an opaque pattern on one side of the transparent material;
printing the first image on the opaque pattern;
printing the second image on the opposite side of the transparent material in areas which are covered by the opaque pattern;
printing the third image on the zones of the transparent material that are not covered by the first and/or the second image.

In a more preferred method the opaque pattern is printed on both sides of the transparent material, preferably the first image is printed on the opaque pattern and the second image is printed on the opaque pattern on the opposite side.

As the security item is a combination of two images printed on the opaque pattern and a third image, printed on the zones of the transparent material that are not covered by the opaque pattern, a counterfeiter will have a problem to separate the different images.

So, it is very difficult to generate the opaque pattern and to print the images in perfect register on the exact position on both sides of the security document. The slightest shift of the images in respect to each other, results in a situation where the images are mixed up with each other, which inevitably will be visible.

Documents according to the invention preferably comprise a transparent synthetic material such as polyethylene, polyester, polypropylene, polycarbonate, polyamide or a combination thereof. However, plastic substrates made from another material are possible as well.

The expression “image” as used in this text refers to any representation, text, message, symbol, pattern and a like, which may be applied in visible form on a document or which can be visualised under specific light circumstances, for example use of an invisible fluorescent ink which becomes visible under black light, the use of Infra-Red (IR) absorbent ink, . . . . According to the invention, the image can be printed in single colour or multicolour. The first, second and third image can be three different images. However, this is not a necessity of the method according to the invention. In this method, two or three images can be identical without departing from the above-defined basic principles of the invention.

As this invention is meant to be printed on a transparent substrate it is clear that beyond the traditional printing technique all possible techniques to transfer to or to generate an image on such a substrate can be used, such as inkjet, thermal transfer, sublimation, etc.

This invention enables the printer of security documents to improve the security level of security documents, through an optimal use of the technical possibilities of existing banknote presses and/or other high tech machinery.

In a preferred method according to the invention the first and the second image are printed in register on both sides of the transparent material, preferably by means of a banknote press, on both sides of the transparent material.

In another preferred method according to the invention the first and the second image and the opaque pattern are printed in register on both sides of the transparent material. Preferably, the opaque pattern is obtained by printing with opaque ink.

In a more preferred method according to the invention the area covered by the first and second image is substantially equal to the uncovered area

Preferably, the zones covered by the first and the second image and the uncovered zones are provided in an alternating sequence.

According to another preferred method the first and the second image are printed in register on both sides of the transparent material. The first image is printed on one side of the transparent material and the second image is printed on the opposite side of said material. Preferably, the third image is printed in see-through register on the uncovered zones of the transparent material. Preferably, the third image can be printed simultaneously with the first and/or second image.

In a most preferred method according to the invention the opaque pattern and/or the images are obtained by applying opaque ink and/or toner and/or foil.

This patent application also relates to a printed security item on a substrate of which at least a part is made of a transparent material wherein a first and a second image are provided on a respective side of the transparent material, wherein the first and second image at least partially overlap, while the transparent zones between the first and the second image carry a third image which is visible or can be visualised in transmission.

The first, second and third image can be three different images. However, this is not a necessity of the printed security document according to the invention. In this document, two or three images can be identical without departing from the above-defined basic principles of the invention.

The printed security item is preferably manufactured according to a method according to one of the claims 1 to 10.

In a more preferred embodiment of the invention said substrate is a security document. More particularly said security document is a banknote.

Additional features and advantages of the invention will be further explained on the basis of non-restricting exemplifying embodiments represented in the attached drawings and in the following detailed description. In this description reference is made to the following drawings in which:

### BRIEF DESCRIPTION OF THE DRAWINGS

FIG. 1 is a representation of the opaque pattern on the front (1a) and on the opposite side (1b) of the substrate;

FIG. 2a is a schematical representation of a printed security item on a substrate provided with an opaque pattern;

FIG. 2b is a schematical representation of a printed security item on a substrate wherein the images are obtained by applying opaque ink, toner and/or foil;

FIG. 3 is the representation of a first image on the opaque pattern on one side of the transparent material;

FIG. 4 is the representation of a second image on the opaque pattern on the opposite side of the transparent material;

FIG. 5 is the representation of the third image on the transparent zones of the material;

FIG. 6 is a representation of the third image which is only visible in transmission, wherein FIG. 6a is viewed from the front side and FIG. 6b viewed from the opposite side;

FIG. 7 is a view from the front side, against a white background;

FIG. 8 is a view from the front side, against a black background;

FIG. 9 is a view from the opposite side, against a white background;

FIG. 10 is a view from the opposite side, against a black background;

FIGS. 11a and 11b are an illustration of the effect when scanning the document in transmission mode;

FIG. 12 is the illustration of the effect when scanning the document in reflection mode from the front side;

FIG. 13 is the illustration of the effect when scanning the document in reflection mode from the opposite side.

### DETAILED DESCRIPTION OF THE PREFERRED EMBODIMENTS

According to the method of the invention, security documents, such as banknotes, printed on a substrate (1) of which at least a part is made of a transparent material, for example polypropylene or polyester (thickness for example 125 micron), can be provided with a new security item via the known banknote presses and/or other high tech machinery.

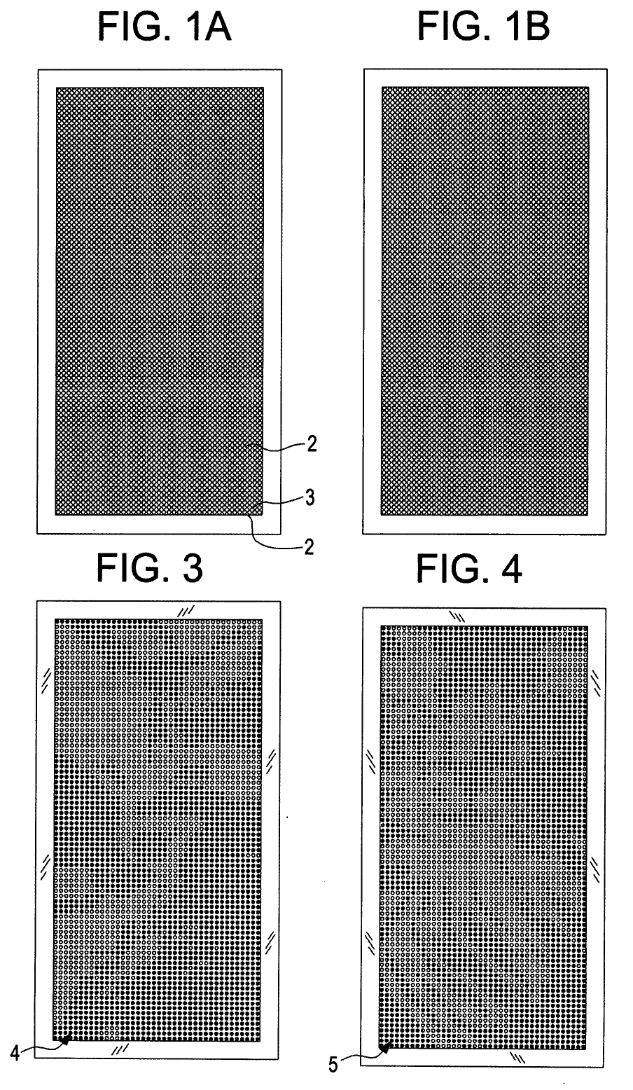

As shown in FIG. 1, the transparent substrate (1) will be partially opacified by printing an opaque screen pattern in white opaque ink in perfect register on both sides of the substrate (1). The created opaque pattern (2) (the white zones on FIG. 1) occur in a mixed relationship with the transparent zones (3) of the material whereby the opacified area is approximately half of the total area of the transparent material. Subsequently, a first (colour) image (4), for example the illustration of a fox (see FIG. 3), is printed, preferably with a transparent ink, on one side of the transparent material (1), in perfect register with the white screen pattern. The opposite side will be overprinted with another image (in transparent ink), a second image (5), for example the illustration of a cat (see FIG. 4), again perfectly on the white dot structure.

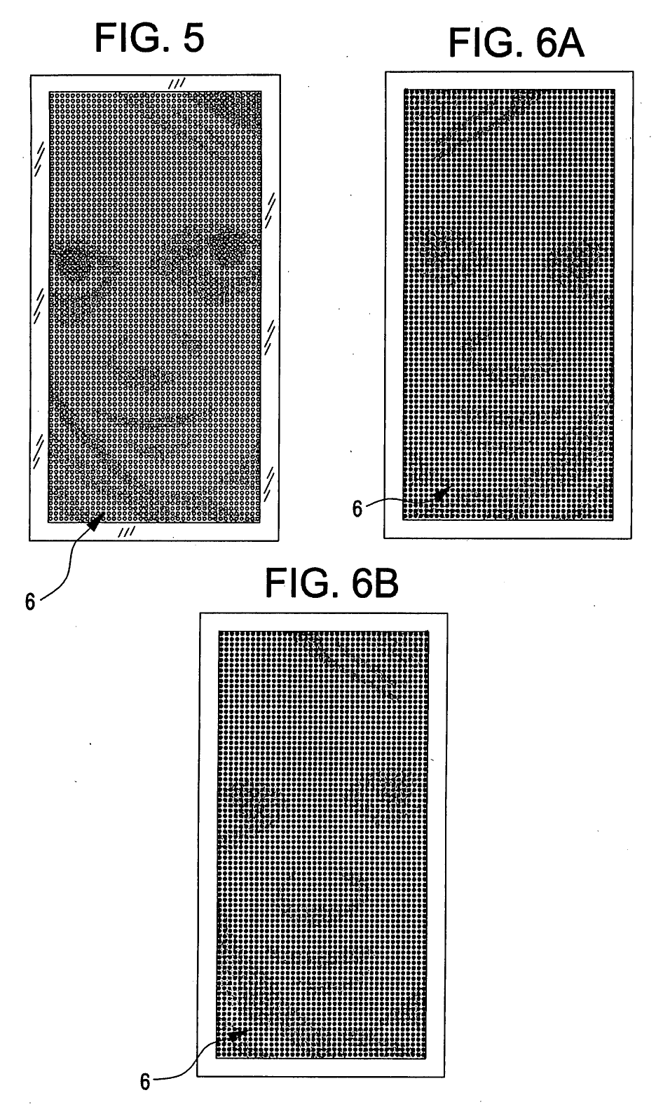

The remaining transparent area will be filled in now by a third image (6) in transparent ink, for example the illustration of a girl (see FIG. 5). The third image can be printed while printing the first (4) and/or second image (5)

Another method for printing a security item on a substrate (1) is shown in FIG. 2b. According to this method a first image (4) is printed in opaque ink on one side of the transparent material, a second image (5) (printed in opaque ink) overprints the first image (5) on the opposite side of the transparent material and the remaining area (3) will be filled with a third transparent image (6).

When one looks at the security item in transmission, only the third image (6), which is printed on the transparent zones (3) is visible. Irrespective of whether one looks from the front side (see FIG. 6a) or the opposite side (see FIG. 6b).

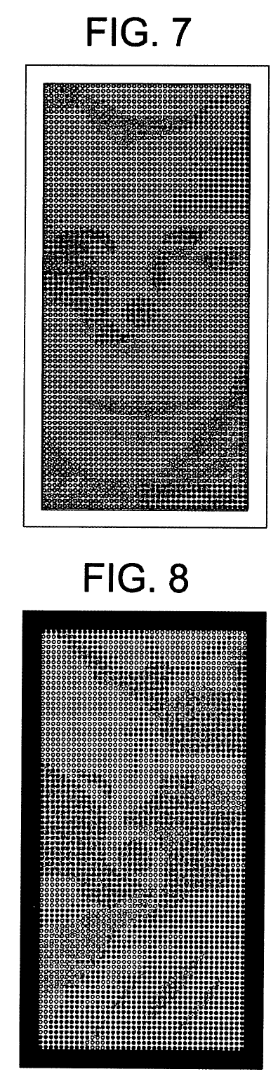

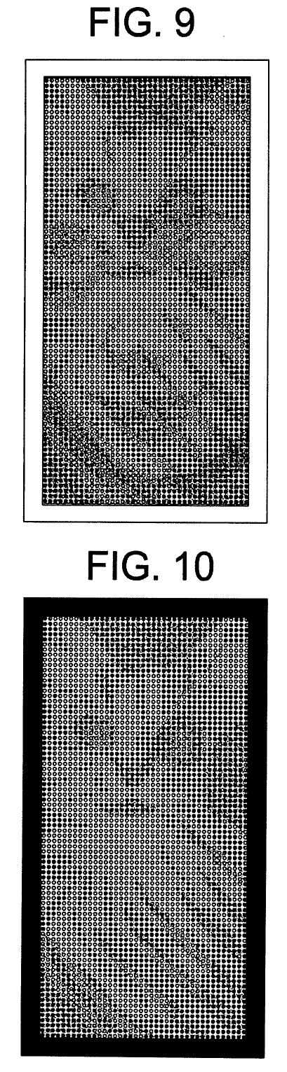

If you look at the security item from the front side, against a white background, then you see, as illustrated in FIG. 7, the image of the fox, which is printed on the front side of the opaque pattern (2) and the image of the girl, which is printed on the transparent zones (3). If you look at the security item from the opposite side, against a white background, then you see, as illustrated in FIG. 9, the image of the cat which is printed on the opposite side of the opaque pattern (2) and also the image of the girl, which is printed on the transparent zones (3)

If you look at the security item from the front side, against a black background, then you see, as illustrated in FIG. 8, only the image of the fox, which is printed on the front side of the opaque pattern. If you look at the security item from the opposite side, against a black background, then you see, as illustrated in FIG. 10, only the image of the cat, which is printed on the opposite side of the opaque pattern (2).

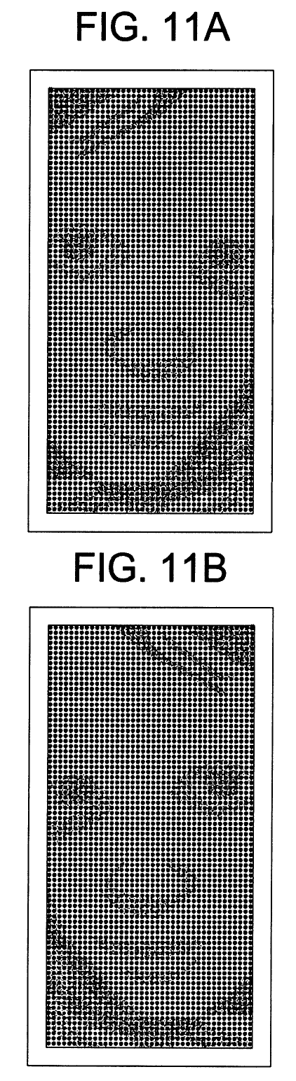

As the security item is a combination of two images (4 and 5), namely a fox and & cat, printed on the opaque pattern (2) and a third image (6), a girl, printed on the transparent zone (3), the counterfeiter will have a problem to separate the different images. So, when a counterfeiter scans a banknote provided with the security element according to this invention in transmission, the images printed on the opaque pattern (2) will disappear. This effect is illustrated on FIG. 11, where only the third image (6) is visible.

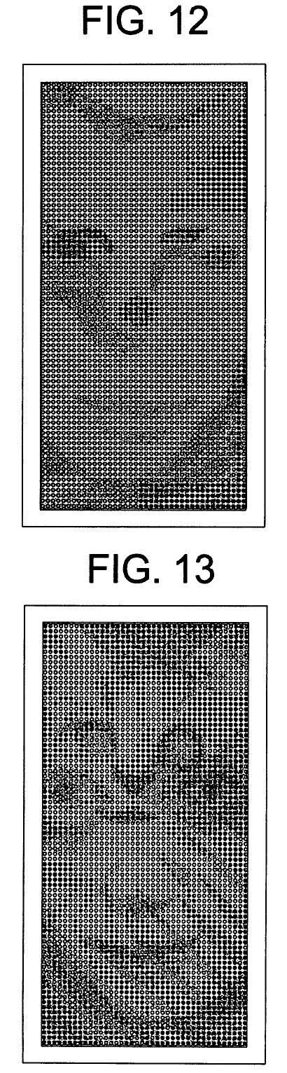

When a counterfeiter scans a banknote provided with the security element according to this invention in reflection, the image printed on the transparent zones (3)—in the present example, a girl—will be mixed up with the image printed on the opaque pattern (2). This effect is illustrated on FIGS. 12 and 13. In FIG. 12 the third image (6) is mixed up with the first image (4), and in FIG. 13 the third image (6) is mixed up with the second image (5).

Even if a counterfeiter would be able to separate the different images, then he still would have the problem to generate the screen pattern and to print the different images in perfect register on the exact position on their respective sides of the security document. The slightest shift of the images in respect to each other, will inevitably result in a situation where the images are mixed up with each other, which inevitably will be visible.

According to this method, banknotes and other security documents can be provided with a security item, which is very difficult to counterfeit and which is easily verifiable. A transparent substrate, which comprises a security item according to the invention can be transferred to or placed on a document, using known technologies and techniques.

The new security item can be combined with other known 15 security features for banknotes.

1. Method for printing a security item on a substrate (1) of which at least a part is made of a transparent material, characterised in that the method comprises the following steps:
printing a first image (4), which is visible or can be visualized, on one side of the transparent material (1);
printing a second image (5), which is visible or can be visualized on the opposite side of the transparent material (1), wherein the first (4) and second (5) image at least partially overlap;
printing a third image (6), which is visible or can be visualized in transmission on the zones of the transparent material that are not covered by the first and/or second image.

2. Method according to claim 1, characterised in that the method comprises the following steps:
first printing an opaque pattern (2) on one side of the transparent material;
printing the first image (4) on the opaque pattern (2);
printing the second image (5) on the opposite side of the transparent material in areas which are covered by the opaque pattern (2);
printing the third image (6) on the zones of the transparent material that are not covered by the first and/or second image.

3. Method for printing a security item according to claim 2, characterised in that the opaque pattern (2) is printed on both sides of the transparent material (1).

4. Method for printing a security item according to claim 3, characterised in that the first image (4) is printed on the opaque pattern (2) and that the second image (5) is printed on the opaque pattern on the opposite side.

5. Method for printing a security item according to claim 1, characterised in that the first, the second and the third image comprise at least two different images.

6. Method for printing a security item according to claim 1, characterised in that the first and the second image are printed in register on both sides of the transparent material (1).

7. Method for printing a security item according to claim 2, characterised in that the first and the second image and the opaque pattern (2) are printed in register on both sides of the transparent material (1).

8. Method for printing a security item according to claim 1, characterised in that the area covered by the first and second image is substantial equal to the uncovered area.

9. Method for printing a security item according to claim 1, characterised in that the zones covered by the first and the second image and the uncovered zones are provided in an alternating sequence.

10. Method for printing a security item according to claim 1, characterised in that the opaque pattern (2) and/or the images (4,5) are obtained by applying opaque ink and/or toner and/or foil.

11. Printed security item on a substrate (1) of which at least a part is made of a transparent material characterised in that a first and a second image are provided on a respective side of the transparent material, wherein the first (4) and second (5) image at least partially overlap, while the transparent zones (3) between the first and the second image carry a third image (6) which is visible or can be visualised in transmission.

12. Printed security item according to claim 11, characterised in that the document is manufactured according to a method according to claims 1 to 10.

13. Printed security item on a substrate according to claim 11, characterised in that said substrate is a security document.
